(19) United States
(12) Patent Application Publication
(10) Pub. No.: US 2012/0018610 A1
(43) Pub. Date: Jan. 26, 2012

(54) Lightlock winch

(75) Inventor: James Kempf, WallKill, NY (US)

(73) Assignee: PRODUCTION RESOURCE GROUP L.L.C., New Windsor, NY (US)

(21) Appl. No.: 13/108,098

(22) Filed: May 16, 2011

Related U.S. Application Data
(60) Provisional application No. 61/334,744, filed on May 14, 2010.

(51) Int. Cl. F21V 21/38; F16M 13/00; F16M 13/02

(52) U.S. Cl. 248/636; 248/328; 248/329

(57) ABSTRACT

Stage usable device, such as a moving light, is held on a platform that is raised and lowered by a winch connected to a truss. The winch can be connected inside the truss, outside the truss such as above or below the truss, or in corner blocks of the truss.

This application claims priority from Application Serial Number 61334744, filed May 14, 2010, the entire contents of which are herewith incorporated by reference.

### BACKGROUND

Winches are used for various purposes, e.g., to move scenery in a stage lighting application.

Lighting devices such as moving lights are often held directly onto a truss by clamps.

### SUMMARY

The present application describes a combination moving light device and winch device, which allows a moving light to be held onto a truss as conventional but also to be raised and lowered on the truss.

### BRIEF DESCRIPTION OF THE DRAWINGS

In the drawings:

FIG. 1 shows a basic embodiment of a device hanging from a truss on a four way bridle;

FIGS. 2A and 2B show an embodiment where the device is on top of the truss;

FIGS. 3A-3C show the device in a truss cornerblock;

FIGS. 4A and 4B show the device inside a truss;

FIGS. 5A and 5B show the device hanging from a truss;

FIGS. 6 and 8 show details of the hanging truss embodiment;

FIG. 7 shows a secondary braking device for an embodiment;

FIGS. 9, 10 and 11 show multiple devices hanging from a truss assembly;

FIGS. 12A and 12B show a moving light hanging from a truss;

FIGS. 13 and 14 show an alternative embodiment.

### DETAILED DESCRIPTION

The present application describes a “lightlock” winch which is a compact winch attached to a truss part. Embodiments show how this winch can be attached in multiple different ways; e.g., into a truss corner block; above the truss; below the truss, in ways described throughout this specification. The lightlock can be used to raise and lower a lighting device. The lighting device can be a conventional moving light, but importantly can also be a light of a type that does not normally hang on a truss. For example, a floor mounted moving light can be held on the platform that is associated with and moved by the lightlock winch device.

The lightlock includes a dampener that keeps automated moving lights from swinging when suspended only on cables.

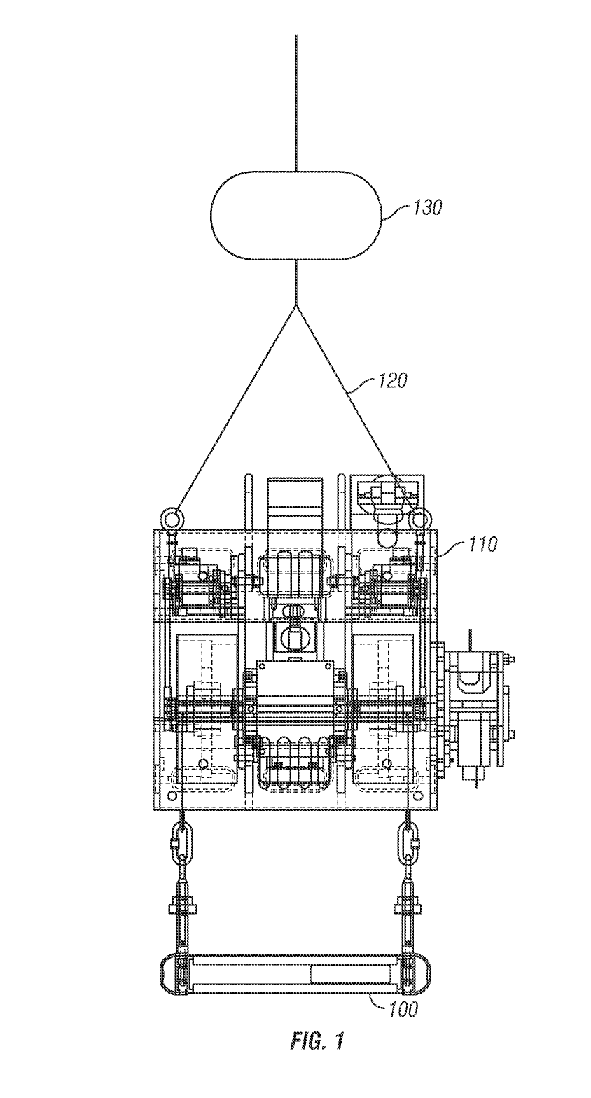

As shown in the drawings, this can be connected to a truss in a number of different ways. The platform 100 for the moving light or other element can be raised and lowered. A hanger bracket for the moving light can have an integral leveling/swivel/bridle. FIG. 1 shows how there can be a chain motor 130 attached to the truss, which itself holds a four-way bridle 120. The four-way bridle 120 can hold the winch assembly 110, that raises and lowers the platform 100. In an embodiment, a moving light is placed on the platform 100.

This allows mounting the winch device 110 in any of a number of different ways, depending on the way that the light is used, and the way that the light sits on the platform. The item on the platform, e.g. the light, can be raised and lowered, and is automatically leveled by the mechanical leveling structure in its raised or lowered position.

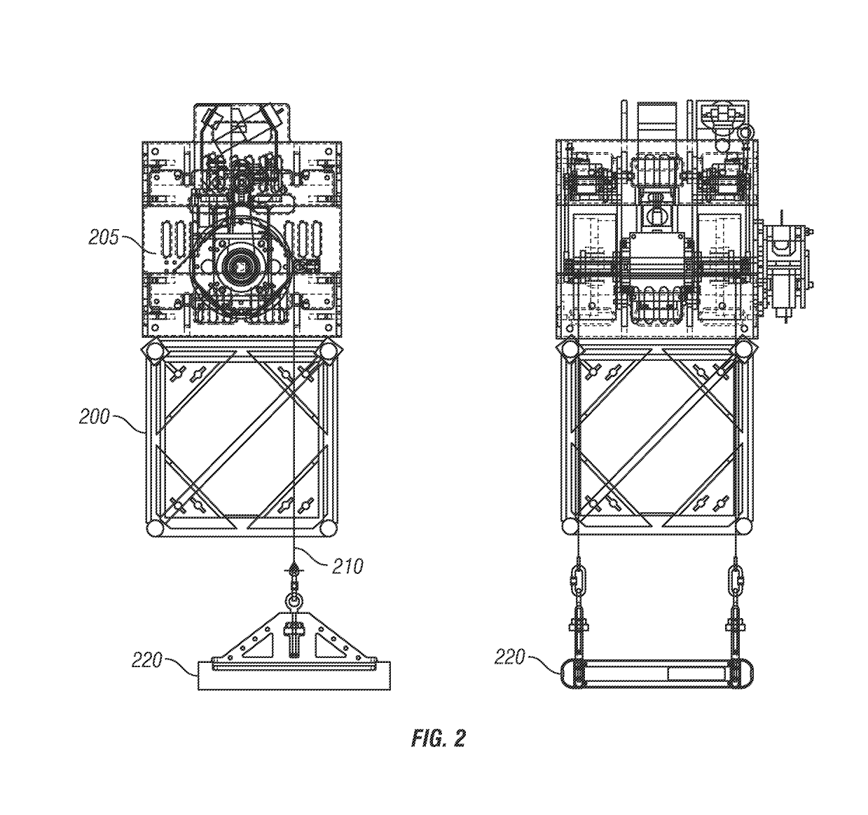

As explained herein, this device can be held within different sections of the truss, and held from different services of the truss. According to one embodiment, the truss may be a substantially square device, having four tubular parts that extend in the same direction. Those four tubular parts are held together by reinforcements. For example, in FIG. 2A, the four tubular parts may be seen as 250, 252, 254, 256. There can be various kinds of cross braces including 258 and 260. However, in general the internal part of the truss, that is the part defined within the opening defined by 250, 252, 254, 256, can be open. While this shows the truss as being a square in cross-section, or other size trusses can be rectangular in general cross-section.

FIG. 1 shows a first embodiment in which the shelf 100 has supports, connected to a motor assembly 110. The motor assembly is itself connected via a four-way bridle 120 to a chain motor 130. The chain motor can be connected by a chain or cable to any desired support such as a truss 140.

FIGS. 2A and 2B shows respectively side and front views of the winch assembly when mounted on top of a truss. Truss 200 is a 20.5 inch truss, which includes the motor assembly 205 connected to the top of the truss. In this embodiment, the bottom of the motor assembly 205 connects to the top truss supports 254, 256. The motor assembly includes two movable support parts, e.g, chains/cable 210 connected to the platform 220. The platform 220 can then be raised up and down by the movement of the motor. Note that in this embodiment, the cables from the motor to the platform 220 may rub up against the truss supports. While this may cause some wear on the cables, it may assist in preventing movement of any device on the platform.

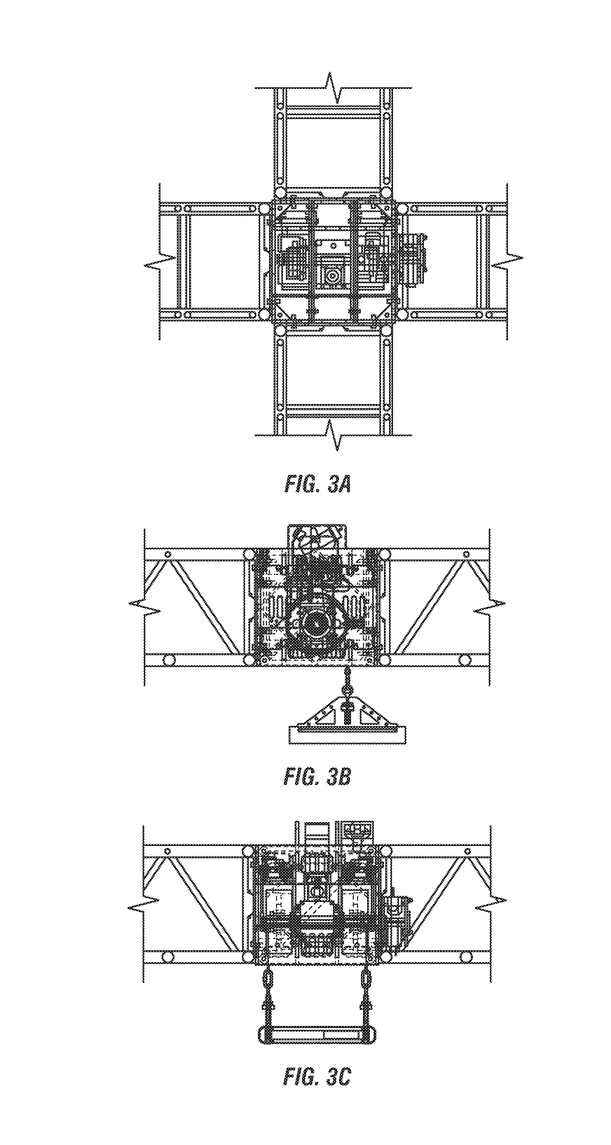

FIG. 3A-3C illustrates another embodiment in which the motorized device is mounted inside of the truss. In FIG. 3A-3C, this is mounted within a corner block of a truss where two truss parts 300 and 310 are mounted together to form a corner. In this way, the motor can be mounted to all four corners of the truss 311, 312, 313, 314, but more generally, is connected to at least one part of each of the two trusses, so that the two trusses each hold at least some of the force from the winch operation. In this embodiment, FIG. 3A shows a plan view, while FIG. 3B shows a side view and FIG. 3C shows a front view. The platform 100 is shown being raised and lowered in this way, with the motor control for the platform being mounted inside the central area of the truss itself.

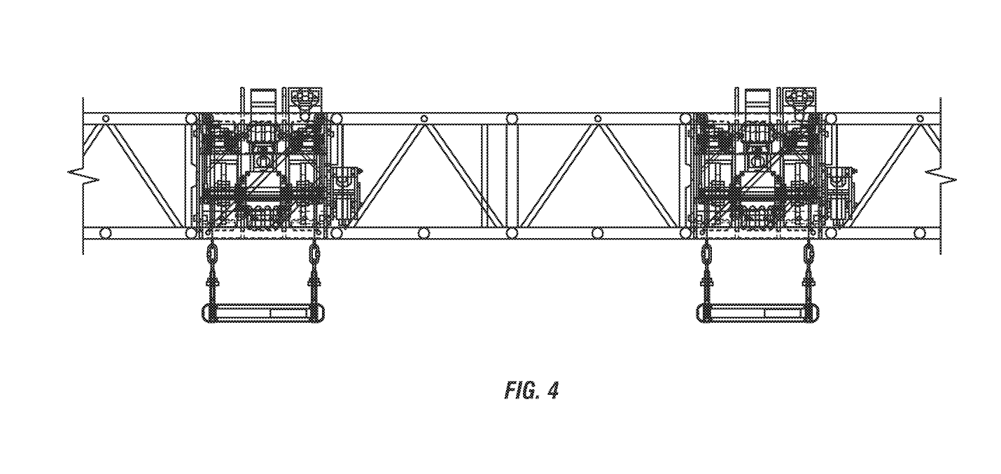

FIG. 4 shows the details of an embodiment where the motor assembly is mounted inside a straight part of the truss, in a non-corner configuration. In this embodiment, the device is mounted within the straight portion of the truss.

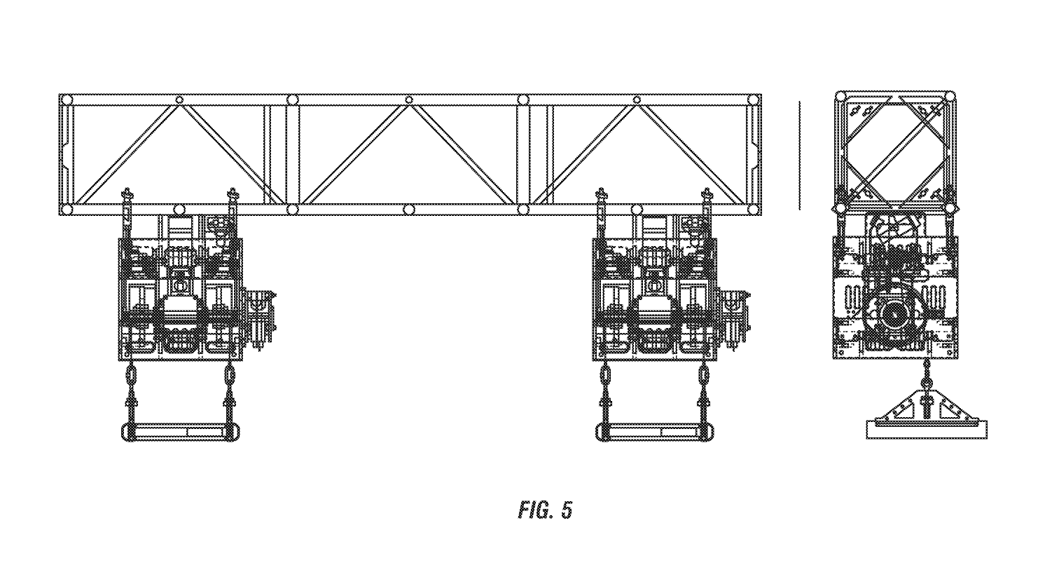

FIGS. 5A and 5B show embodiments where the motor assembly is mounted outside the truss but hanging from the bottom support of the truss. FIG. 5A illustrates a front on view of the truss showing the long axis of the truss 500. The devices are hung from first and second hanger parts 502, 504 to hang from the trusses. FIG. 5B shows a side view, showing how these hanger parts such as 502 can have a generally hook shaped part 510 that hooks around the bottom cylindrical section 512 of the truss.

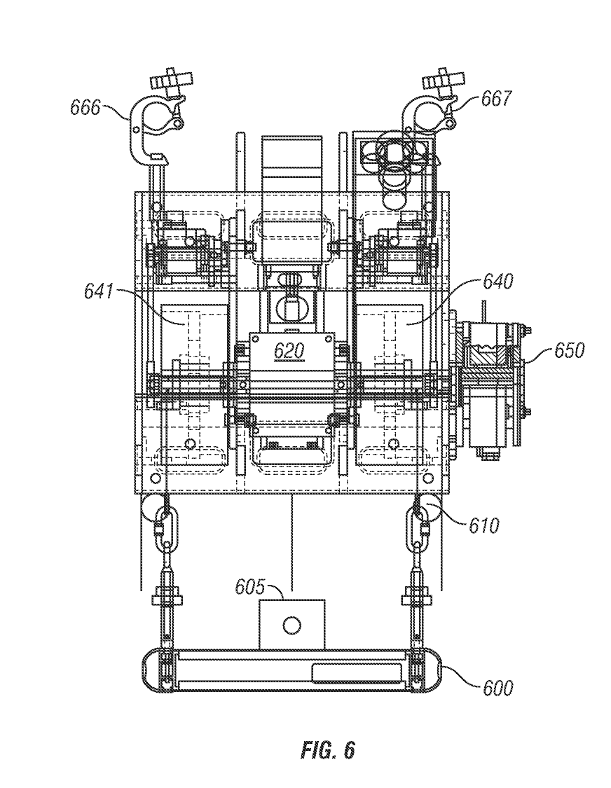

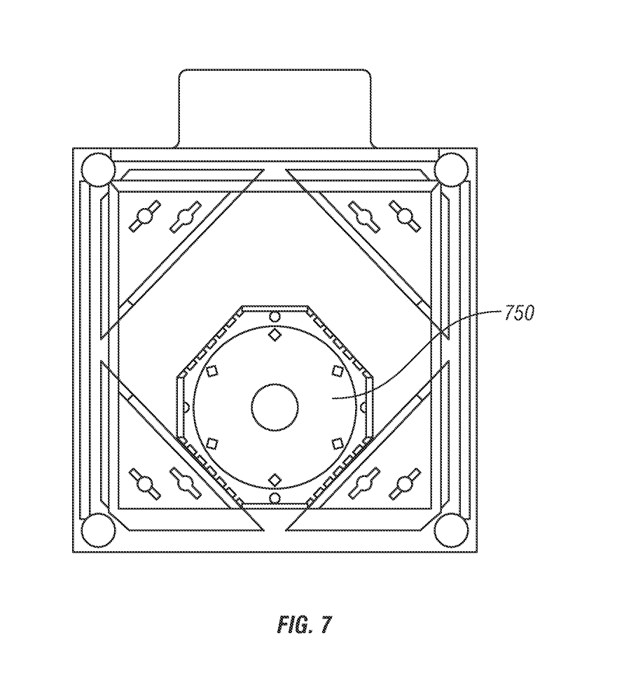

FIG. 6 illustrates a further view of the device including the platform 600 on which the moving light 605 can be located. The platform 600 can be raised and lowered via cables 610 driven by the motor 620 which rotates to pay the cables 610 on and off of the cable spools 640, 641. A motor brake 650 can connect into the motor and/or cable spools 640, 641. The entire device is held on the truss in this embodiment by truss clamps shown as 666, 667. The truss clamps can, as shown, attach into the housing 601 of the motor device, and hence can be attached to and removed from the assembly depending on its desired mounting configuration. For example, in other embodiments, the housing 601 can be mounted directly on the trusses or inside the outer perimeter of the trusses as shown in other Figures. Note that in the embodiment where the device is inside the truss, the motor brake shown as 750 in FIG. 7 can nest inside an adjoining truss section.

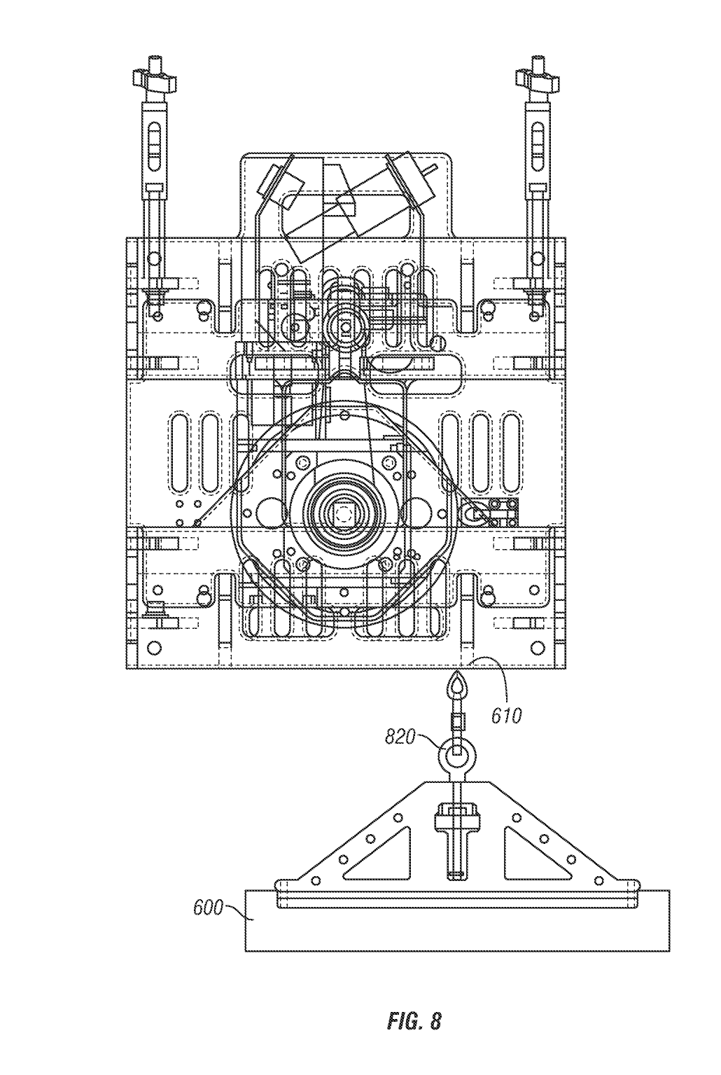

FIG. 8 shows a side view of the structure shown in FIG. 6, showing the cable 610, as well as the platform 600. Note that the platform is held on an eye portion 820 which automatically forces side to side leveling of the device independent of the level of the motor (assuming that the load on the platform is balanced). In another embodiment, there can be multiple cables holding the platform at each of the four corners, to force balancing even if an unbalanced load is placed on the platform 600.

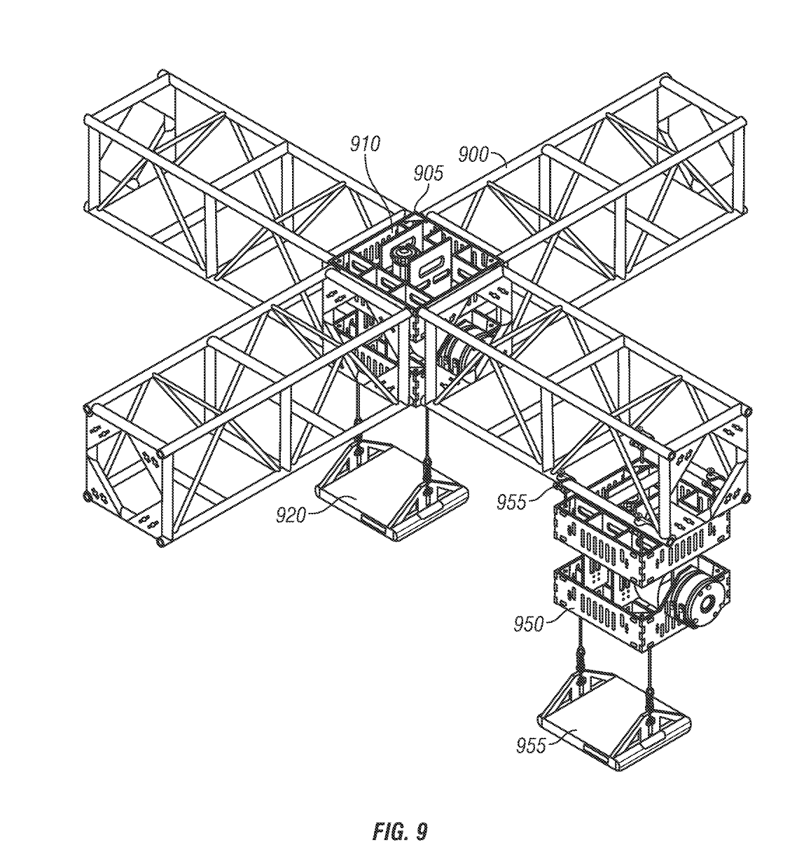

FIG. 9 illustrates a truss 900 as it might be mounted in a venue. This illustrates how the motorized devices according to the different embodiments can be mounted in different ways. The truss itself 900 is shown with a crossbar portion, at the area 905. The motor assembly 910 for a first truss is mounted within that crossbar area 905. This raises and lowers the first platform 920, which may, for example, hold a moving light.

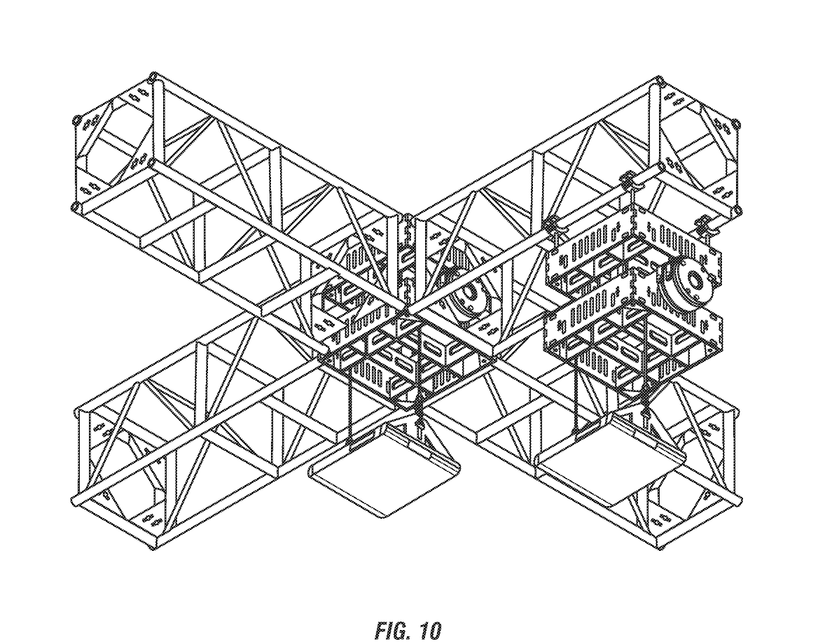

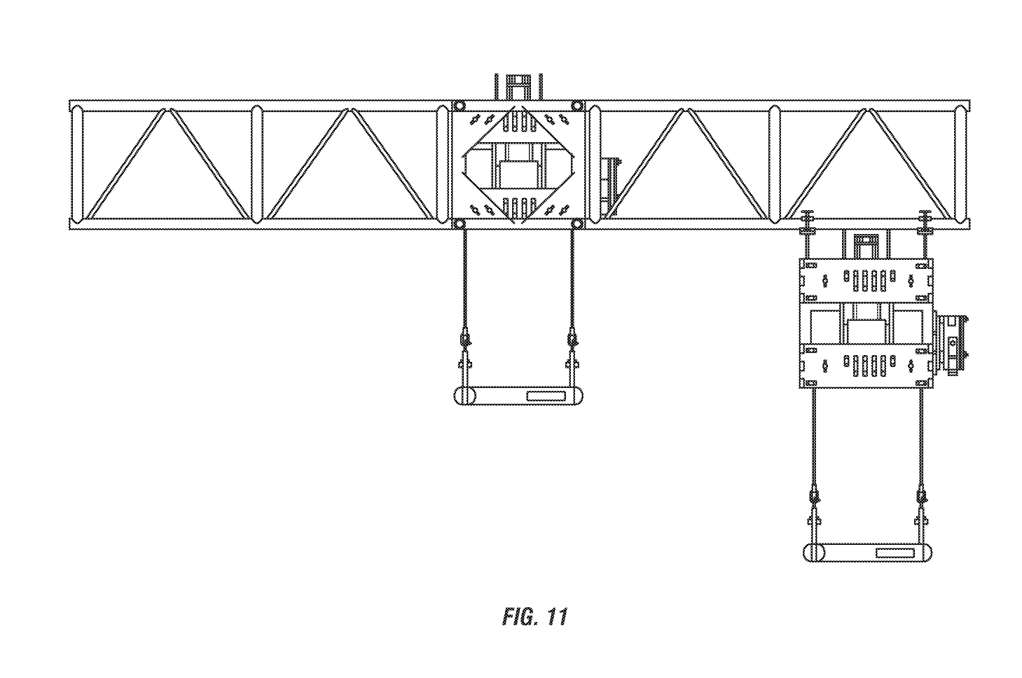

The second motor assembly 950 is mounted outside and under the truss, connected to the truss by the clamps 955. Again, this second device raises and lowers a second platform 955. FIG. 10 shows a bottom view of these trusses and devices, while FIG. 11 shows a front view of the two trusses.

The other figures show additional details of the different embodiments and the different construction of the structure.

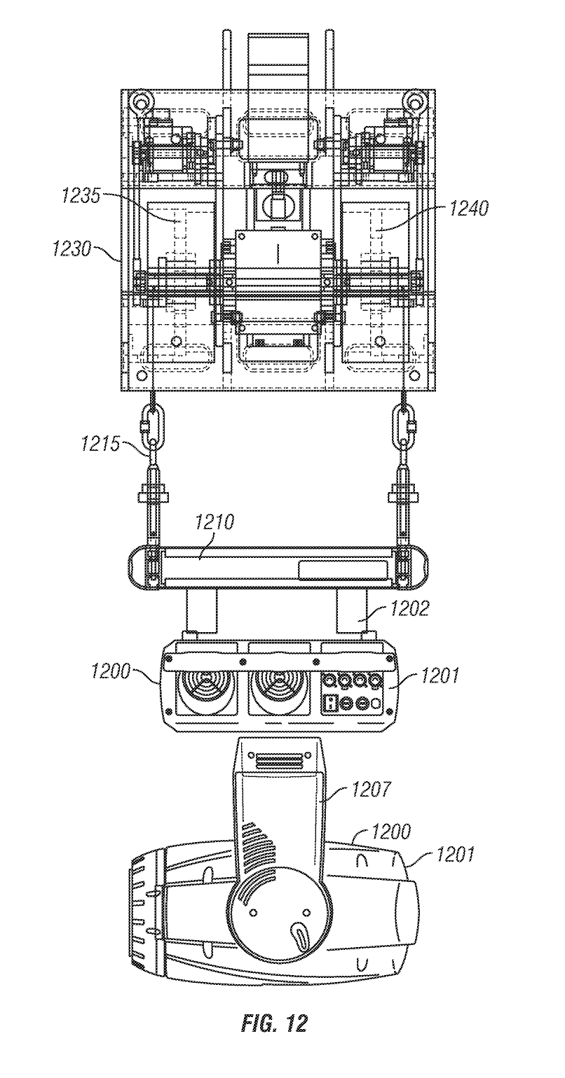

FIGS. 12 A and B illustrates an alternative embodiment which has additional features. In the FIG. 12 embodiment, moving light 1200 is held on a dampener 1215 that supports a platform 1210 that is raised and lowered on cables. The lightlock device itself 1230 may have a number of cable spools such as 1235, 1240 which raise and lower the dampener-supported platform. FIG. 12 B shows a side view of the light 1200 showing how its back portion 1201 has the fans and connections. The yoke portions 1202 of the light are held to the dampener. The dampener may itself include springs and/or pistons which dampen the oscillatory motion.

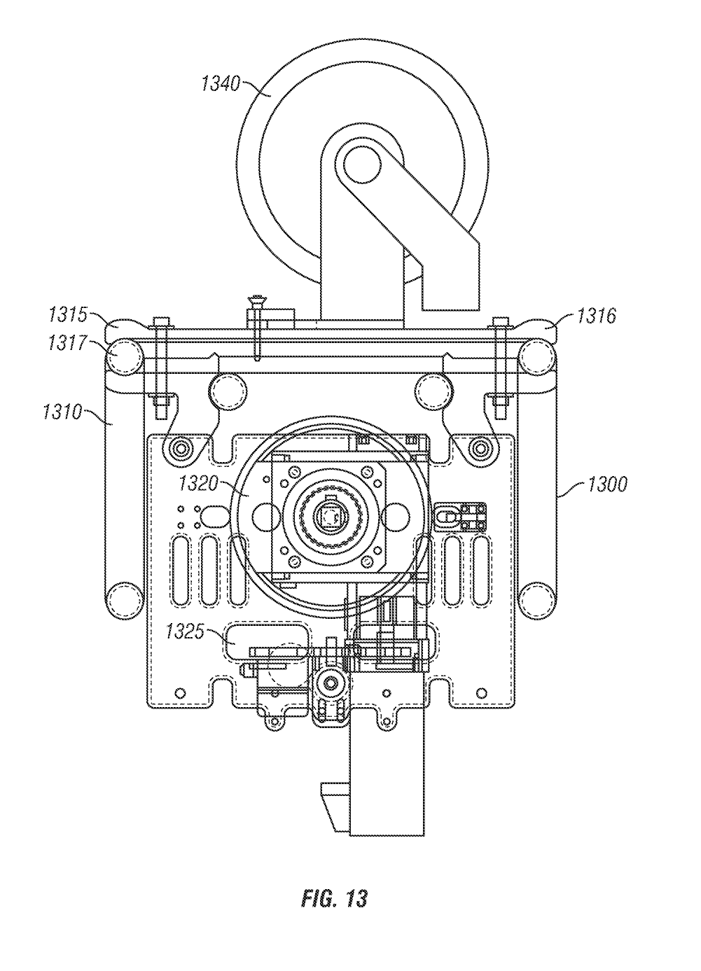

Another embodiment shown in FIG. 13 eliminates many of the hanger brackets of the FIGS. 1-11 embodiment, and instead just uses cable bridles. This embodiment uses an assembly 1300 which may be held within the truss by connecting to the different truss poles 1317, 1350, 1351 1352. This embodiment uses clamps to connect to at least some of these truss parts. This embodiment has only limited mounting functionality, and hence is referred to as the “naked” version. This has a housing 1310 which is held by truss clamps 1315, 1316 to the respective parts of the truss such as 1317. Cable reels such as 1320 enable raising and lowering the platform 1325 to which the payload may be attached.

Additional cable reel 1340, which allows the truss itself to be raised and lowered using the lightlock device, with an additional raising and lowering of the payload, e.g., the moving light, therein.

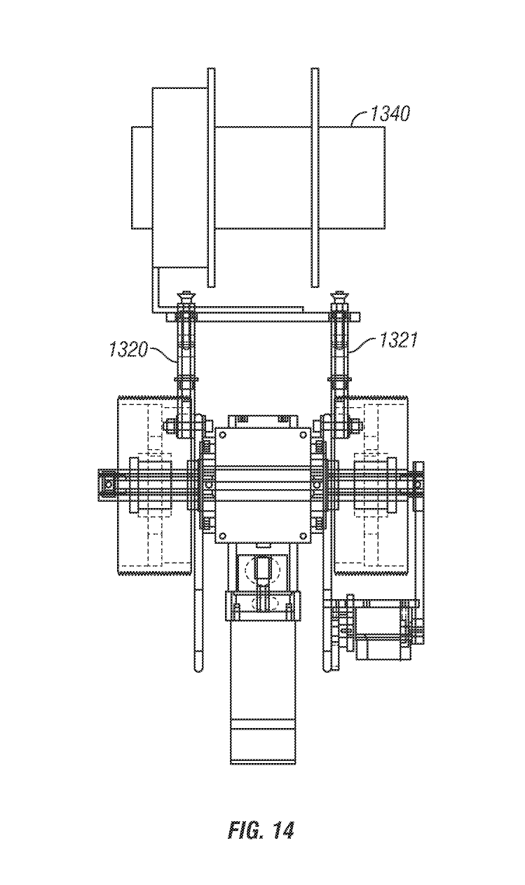

FIG. 14 shows a side view of the FIG. 13 embodiment, showing the cable reel 1320, and an additional cable reel 1321, raising and lowering the platform.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, this can use a winch to raise and lower any movable support part, which is referred to in this specification as cable, or chain, but can also be a belt, a rigid ribbed part or any other movable part.

Also, the inventor intends that only those claims which use the words “means for” are intended to be interpreted under 35 USC 112, sixth paragraph. Moreover, no limitations from the specification are intended to be read into any claims, unless those limitations are expressly included in the claims.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A truss mounted device for raising and lowering a moved device, comprising:
a housing having parts that connect to a truss, said housing connecting in a first configuration to an inside of the truss to have the housing mounted inside an area defined by an outer periphery of the truss, and connecting in a second configuration to an outside of the truss to have its housing mounted outside said outer periphery;
a motor, inside said housing;
a movable support part, moved by said housing; and
a platform, connected to said movable support part, and moved by movement of said motor to move closer to said housing and further from said housing based on the movement of said motor, said platform having a surface for holding a stage-usable device.

2. The device as in claim 1, wherein said stage-usable device is a moving light.

3. The device as in claim 2, further comprising a spool, attached to said motor, and wherein said movable support part is stowable on said spool.

4. The device as in claim 1, further comprising a clamp attachable to said housing, which holds said housing to at least two connection parts in said truss.

5. The device as in claim 1, wherein said second configuration mounts said housing above the truss.

6. The device as in claim 1, wherein said second configuration mounts said housing below the truss.

7. The device as in claim 6, further comprising hook shaped clamps which attach to said housing and hold to surfaces of said truss to hold the housing inside the truss, wherein said first configuration is inside the truss.

8. The device as in claim 1, wherein said first configuration is inside a corner block of the truss, and where said housing is connected to four different portions of the truss.

9. The device as in claim 1, further comprising a damper, connected to said platform, to damp motion of said platform.

10. The device as in claim 1, wherein said platform includes a top surface and a bottom surface, and both said top surface and said bottom surface have structure to hold said stage-usable device.

11. A stage assembly comprising:
a first truss extending in a first direction;
a second truss, extending in a second direction substantially perpendicular to the first direction, and intersecting the truss at a corner block where said first truss and said second truss intersect;
a housing having parts that connect to each of said first and second trusses;
a motor, inside said housing;
a movable support part, moved by said housing; and
a platform, connected to said movable support part, and moved by movement of said motor to move closer to said housing and further from said housing based on the movement of said motor, said platform having a surface for holding a first lighting device.

12. An assembly as in claim 11, further comprising a second housing, hanging below a bottom surface of the truss at a different location and that only holds to one of said first or second trusses, and holding in the corner block, and holding a second lighting device.

13. An assembly as in claim 11, where said second connecting in a first configuration to an inside of the truss to have the housing mounted inside an area defined by an outer periphery of the truss, and connecting in a second configuration to an outside of the truss to have its housing mounted outside said outer periphery.

14. The device as in claim 11, wherein said first lighting device is a moving light.

15. The device as in claim 11, further comprising a spool, attached to said motor, and wherein said movable support part is stowable on said spool.

16. The device as in claim 11, wherein said second configuration mounts said housing above the truss.

17. The device as in claim 11, wherein said second configuration mounts said housing below the truss.

18. The device as in claim 11, further comprising a damper, connected to said platform, to damp motion of said platform.

19. The device as in claim 11, wherein said platform includes a top surface and a bottom surface, and both said top surface and said bottom surface each have structure to hold said lighting device.

20. A method of raising and lowering a stage usable device on a truss, comprising:
connecting a housing in a first configuration to an inside of the truss to have the housing mounted inside an area defined by an outer periphery of the truss;
connecting the housing in a second configuration to an outside of the truss to have its housing mounted outside said outer periphery;
mounting the stage usable device on a platform that is attached to the housing;
raising and lowering the platform relative to the housing while holding a stage-usable device thereon.

21. The method as in claim 20, wherein said stage-usable device is a moving light.

22. The method as in claim 20, wherein said first configuration is inside a corner block of the truss, and where said housing is connected to four different portions of the truss.

23. The method as in claim 20, further comprising damping motion of said platform.

24. A method as in claim 20, further comprising mounting the stage usable device on a top surface of the platform in a first configuration and on a bottom surface of the platform in a second configuration.
